(19) United States
(12) Patent Application Publication
(10) Pub. No.: US 2025/0328825 A1
(43) Pub. Date: Oct. 23, 2025

(54) SYSTEM THAT MODELS AND STOCHASTICALLY CO-OPTIMIZES MANUFACTURING AND SUPPLY CHAIN METRICS

(71) Applicants: Eric Charles Maass, Scottsdale, AZ (US); Ryan C. Panos, Scottsdale, AZ (US)

(72) Inventors: Eric Charles Maass, Scottsdale, AZ (US); Ryan C. Panos, Scottsdale, AZ (US)

(21) Appl. No.: 19/079,620

(22) Filed: Mar. 14, 2025

Related U.S. Application Data
(60) Provisional application No. 63/636,175, filed on Apr. 19, 2024.

(51) Int. Cl. G06Q 10/04

(52) U.S. Cl. CPC G06Q 10/04

(57) ABSTRACT

A system and method for stochastic optimization of manufacturing and supply chain processes are disclosed. The system comprises a processor and memory configured to receive a plurality of tasks associated with a process, along with data items for each task. The data is processed through various modeling modules, including yield, cycle time, throughput, on-time delivery, cost, and financial results modeling modules. The system analyzes the data to determine metrics and provides recommendations for optimization. The method includes steps for determining statistical distributions, identifying bottlenecks, calculating cycle times, and refining estimates to improve process efficiency. The system outputs metrics and recommendations via a user interface, enabling proactive management and optimization of manufacturing and supply chain metrics. This approach addresses the limitations of traditional heuristic and deterministic models by providing a comprehensive, integrated solution for process optimization.

### CROSS-REFERENCE TO RELATED APPLICATIONS

This application claims the benefit of priority of U.S. provisional application No. 63/636,175, filed Apr. 19, 2024, the contents of which are herein incorporated by reference.

### FIELD

The present disclosure relates to model systems, and, more particularly, to a system and method for modeling and co-optimizing manufacturing and supply chain metrics.

### BACKGROUND

As companies grow, scaling can become an issue of critical importance, especially with respect to supply chain growth. Typically, a company follows a static supply chain model that can become stale and no longer reflects the business realities of the company, in which case new models must be selected. Existing approaches for selection of supply chain models, such as LEAN and Factory Physics, involve heuristics, and/or deterministic models. LEAN relies on a set of heuristics that are effective in some situations but inappropriate in other situations and does not provide predictions of results for the business. Factory Physics provides individual deterministic models for a few metrics, notably Cycle Time and Throughput, but does not integrate nor expand to all key metrics, which can lead to suboptimization. These approaches tend to be reactive rather than proactive.

As can be seen, there is a need for a proactive system for modeling and co-optimizing manufacturing and supply chain metrics, that comprehends factors outside direct control and provides a proactive approach to co-optimize metrics.

### SUMMARY OF THE INVENTION

Broadly the present invention provides a system and method for stochastic optimization of a process, such as a manufacturing process. In embodiments of the present invention a plurality of tasks associated with the process are received, or input by a user of the system. In embodiments of the present invention at least one data item for each task is received and is provided to one or more modeling, or analysis, modules for further processing. In embodiments of the present invention the one or more modeling, or analysis, modules can analyze, compute, or otherwise process the at least one data item for each task to determine one or more models, metrics, estimates, calculations, etc. In embodiments, the one or more models, metrics, estimates, calculations, etc., can be output via at least one user interface, and/or provided to another one or the one or more modelling modules for further processing and analysis.

### BRIEF DESCRIPTION OF THE DRAWINGS

FIG. 1 is a block diagram of an embodiment of a stochastic modeling system, according to aspects of the present disclosure; and

FIG. 2 is a flow diagram of a method for stochastic modeling for manufacturing and supply chains, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As stated above, current supply chain and manufacturing modeling systems rely on heuristic and/or deterministic models that are reactive in nature.

Broadly, an embodiment of the present disclosure provides a system and method for stochastic modeling and co-optimizing manufacturing and supply chain metrics and provides a summary of each manufacturing metric, identifies the bottleneck, identifies tradeoffs and provides the user with a dashboard summarizing the manufacturing metrics and recommendations to meet expectations.

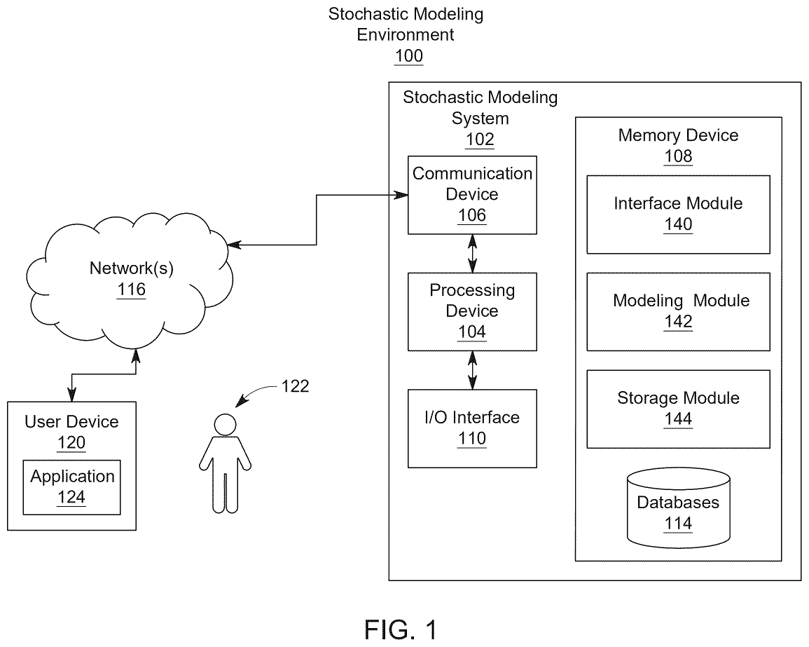

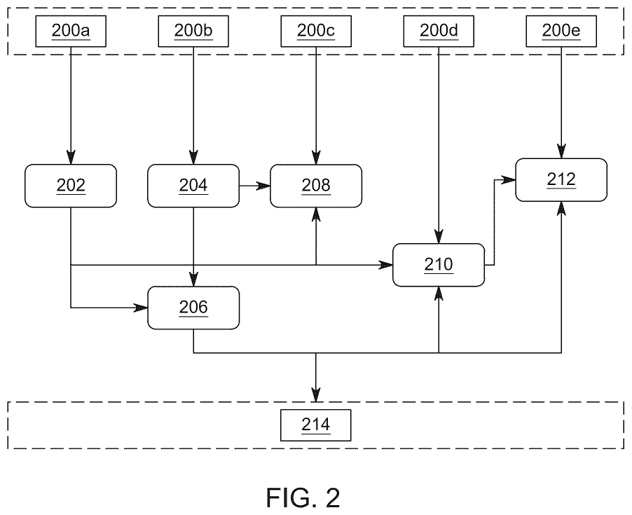

Referring now to FIGS. 1-2, FIG. 1 illustrates a block diagram of an embodiment of a stochastic modeling system, according to aspects of the present disclosure. While FIG. 1 illustrates various components of the Stochastic Modeling Environment 100, additional components can be added, and existing components can be removed.

As illustrated in FIG. 1, the Stochastic Modeling System 102 includes one or more processing devices, herein processing device 104, coupled to a communication device 106. The processing device 104 is also coupled to a memory device 108, and an input/output (“I/O”) interface 110. In embodiments, the communication interface 104 enables the Stochastic Modeling System 102 to communicate with other devices and systems via one or more networks 116. The Stochastic Modeling System 102 can communicate with a user device 120 via the network 116. A user 122 can utilize the user device 120 to communicate with the Stochastic Modeling System 102. The user device 120 can include one or more electronic devices such as a laptop computer, a desktop computer, a tablet computer, a smartphone, a thin client, a smart appliance, and the like. While FIG. 1 illustrates one user device 120, the Stochastic Modeling Environment 100 can include multiple user devices operated by the user 122 or operated by other users.

According to the aspects of the present disclosure, the Stochastic Modeling System 102 enables the user 122, operating a copy of an application 124 executing on the user device 120, to communicate with the Stochastic Modeling System 102 and leverage the service provided by the Stochastic Modeling System 102. The Stochastic Modeling System 102 is configured to identify primary manufacturing and supply chain metrics, integrate models for each of the manufacturing and supply chain metrics, provide recommendations using stochastic modeling, and optimize each of the metrics.

To perform the process described herein, the Stochastic Modeling System 102 can store and execute an Interface module 140, a Modeling module 142, and an Storage module 144 to perform the processes and methods described herein. The Interface module 140, the Modeling module 142, and the Storage module 144 can be stored in the memory device 108. The Interface module 140, the Modeling module 142, and the Storage module 144 can include the necessary logic, instructions, and/or programming to perform the processes and methods described in further detail below. The Interface module 140, the Modeling module 142, and the Storage module 144 can be written in any programming language.

In embodiments, the application 124 can be a specifically designed application that operates with the Stochastic Modeling System 102 to perform the processes and methods described herein. In embodiments, the application 124 can be a third-party application, such as a web browser, that communicates with the Stochastic Modeling System 102 to perform the processes and methods described herein. The memory device 108 can also include one or more databases 114 that store information and data associated with the process and methods described below in further detail.

According to aspects of the present disclosure, the Stochastic Modeling System 102, for example, via the Interface module 140, provides unique interfaces that allow the user 122 to provide/update/modify inputs/metrics, review dashboards, scenarios, what-ifs, select models, etc. The Interface module 140 operates to generate and provide graphical user interfaces (GUIs) to the application 124, for example, menus, widgets, text, images, fields, etc., as described below in further detail. The GUIs generated by the Interface module 140 can be interactive. The Stochastic Modeling System 102, for example, via the Interface module 140, also provide one or more application programming interface (APIs) that provide connection points for one or more application, e.g., the application 124.

In embodiments, the Interface module 140 can implement voice control aspects into the interfaces provided. For example, the user can navigate the interfaces of the Stochastic Modeling System 102 using the audio input device of the user device 120. The interface module 140 can implement one or more chat-bots to deliver conversational input and output to a user.

The processing device 104, the communication device 106, the memory device 108, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the Stochastic Modeling System 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 108, the Stochastic Modeling System 102 can include multiple memory devices 108, whether the same type or different types.

The communication device 106 enables the Stochastic Modeling System 102 to communicate with other devices and systems. The communication device 106 can include, for example, a networking chip, one or more antennas, and/or one or more communication ports. The communication device 106 can generate radio frequency (RF) signals and transmit the RF signals via one or more of the antennas. The communication device 106 can generate electronic signals and transmit the RF signals via one or more of the communication ports. The communication device 106 can receive the RF signals from one or more of the communication ports. The electronic signals can be transmitted to and/or from a communication hardline by the communication ports. The communication device 106 can generate optical signals and transmit the optical signals to one or more of the communication ports. The communication device 106 can receive the optical signals and/or can generate one or more digital signals based on the optical signals. The optical signals can be transmitted to and/or received from a communication hardline by the communication port, and/or the optical signals can be transmitted and/or received across open space by the communication device 106.

The communication device 106 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The Stochastic Modeling System 102 can communicate with one or more network resources via the network 116. The one or more network resources can include external databases, social media platforms, search engines, file servers, web servers, or any type of computerized resource that can communicate with the Stochastic Modeling System 102 via the network 116.

As described above, the Stochastic Modeling System 102 can include hardware components to perform the processes described herein. In embodiments, one or more of components, hardware, and/or functionality of the Stochastic Modeling System 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the Stochastic Modeling System 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine data that is computer-readable. Content and/or data can refer to human-readable text.

Various of the devices in the Stochastic Modeling Environment 100, including the Stochastic Modeling System 102 and/or the user device 120 can provide I/O devices for outputting information in a format perceptible by a user and receiving input from the user. For example, the Stochastic Modeling System 102 can communicate with the I/O devices via the I/O interface 110. The I/O devices can display graphical user interfaces (“GUIs”) generated by the Stochastic Modeling System 102. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

FIG. 2 illustrates a method for stochastic modeling and optimization of manufacturing and supply chain metrics 200, according to aspects of the present disclosure. While FIG. 2 illustrates various stages of the method, additional stages can be added, and existing stages can be removed and/or reordered. The method of FIG. 2 can be implemented on the system of FIG. 1, and/or as the functionality of one or more modules of system 102, such as Interface Module, 140, Modeling Module 142, and/or Storage Module 144 of system 102.

In embodiments, a user can input information regarding a sequence of steps or tasks in at least one manufacturing process(es), and inputs related to a yield, a processing time and a capacity associated with each step or task, in the sequence of steps or tasks as will be described. The user can input information for the at least one manufacturing process(es) as a whole in terms of financial information such as costs and can provide information in terms of desired outputs such as desired on time delivery percentage, quoted lead times and yield assumptions to start material into the at least one manufacturing process.

At Yield Modeling step 202, the user can input at least one task of at least one manufacturing process. In embodiments, the at least one task, also referred to at least one step of a manufacturing process, can include, but are not limited to: deposition of a layer of material onto a substrate; a heat treatment to bond layers of material together; insertion or attachment of a component onto an assembly; and/or any other task for a manufacturing process known in the art. For each task of the at least one manufacturing process, the user can decide if the yield is parametric (a continuous parameter within the specification limits) or defect related (a pass or fail criteria such as passing or failing an inspection).

If a yield is Parametric, the user can either provide at least one information describing the distribution of at least one measured characteristic of the at least one task, such as the mean and standard deviation, along with the nearest specific limit, or the user can provide a summary statistic such as a process capability index, a Z-score, a percent of units expected to have the at least one measured characteristic that fits within a specification limit(s), hereinafter Probability of Compliance, or outside of a specification limit, hereinafter Probability of Non-compliance.

If a yield is Defect-related, the user can provide at least one information of the at least one task such as, estimates of the expected number of parts that would pass the inspection and the expected number of parts that would fail the inspection. In embodiments, defect determination can be performed by visual inspection, although it also could be assessed by automated means, such as testing for electrical continuity (e.g. an open circuit or a short circuit) or other sensing element (e.g. sensing heat, sound, electromagnetic radiation, etc.).

Next, the at least one parametric information, or the at least one defect-related information, can be converted into one or more statistical parameters for a statistical distribution. In embodiments, the statistical distribution can be a Beta distribution, and the one or more statistical parameters can be alpha and beta. In embodiments, the at least one parametric information, and/or the at least one defect-related information can be converted to at least one expected average yield, and/or at least one standard deviation of the at least one expected average yield. From the at least one expected average yield and/or the at least one standard deviation of the at least one expected average yield parameters, the one or more statistical parameters can be calculated.

In embodiments, calculation of the one or more statistical parameters varies based on the type of yield of the at least one task. In embodiments, if the yield of the at least one task is determined to be parametric by the user, the one or more statistical parameters can be calculated as follows:

$$alpha = \frac{{( average yield )}^{2} - {( average yield )}^{3}}{{( standard deviation )}^{2}} - average yield ; and$$

$$beta = alpha * \frac{1 - average yield}{average yield} .$$

In embodiments, if the yield of the of the at least one task is determined to be defect related, by the user the one or more statistical parameters can be calculated as follows: alpha (expected number of parts that would pass inspection+1); and beta=expected number of parts that would not pass inspection+1).

Once the one or more statistical parameters has been calculated an overall Beta distribution can be created for each task provided of the at least one manufacturing process. To calculate an overall Beta distribution, an overall average yield can be calculated as the product of the average yields for each of the at least one tasks of the at least one manufacturing process. Additionally, the contribution of the estimated variance for each task of the at least one task of the at least one manufacturing process can be estimated by taking the partial derivative of an overall yield equation with respect to the yield of each task of the at least one task of the at least one manufacturing process. The partial derivative is multiplied by the standard deviation of the average yield for each task of the at least one task of the at least one manufacturing process, as describe earlier, and that product is squared. The variance contributions for each task of the at least one task can be summed up as the variance of the overall yield, and the square root of that sum can be the predicted standard deviation of overall yield of the at least one manufacturing process. In embodiments, the contribution of the estimated variance for each task of the at least one task of the at least one manufacturing process can be converted into a graphical display, such as a Pareto char showing which of the at least one tasks contribute the most to the overall variance of the overall average yield.

In embodiments, once the overall average yield and the variance of the overall yield are calculated they can be converted into an overall alpha and beta for the overall Beta distribution. In embodiments, if the overall average yield of the at least one task of the at least one manufacturing process is determined to be parametric by the user, the one or more statistical parameters can be calculated as follows:

$$alpha = \frac{{( overall average yield )}^{2} - {( overall average yield )}^{3}}{{( overall standard deviation )}^{2}} - overall average yield ; and$$

$$beta = alpha * \frac{1 - overall average yield}{overall average yield} .$$

In embodiments, one or more information from the at least one task of the at least one manufacturing process can be provided to the user as a one or more outputs 214, such as a Histogram, Pareto Chart, or Tornado Diagram, as a graphical representation of the contribution of each task or step to the variability of the probability distribution of overall yield through the sequence of steps. In an exemplary embodiment, the one or more information can be a distribution of the yield, represented as a Histogram, or sensitivity diagram, such as a Tornado Diagram. Finally, one or more suggestions can be provided as an output 214 to the user on ways to improve the overall yield through the sequence of steps. For example, a most impactful task identified by the Yield modeling step 202, as the task most effecting the overall yield, can then utilize Yield Surface Modeling to provide optimal setting for a machine used in manufacturing to optimize yield, if said task involves parametric yields. Alternatively, if the most impactful task involves defect-related yields, Binary Logistic Regression can be utilized for optimization.

At Cycle time modeling step 204, the user can input at least one task of at least one manufacturing process or reuse one or more tasks input by the user in the Yield Modeling step 202. For each task of the at least one task, one or more data items can be provided by the user, and/or calculated or estimated. In embodiments, the one or more data items can include at least one timing information and at least one process information. In embodiments, the at least one timing information can include information on average or expected time for each task of the at least one task, such as a minimum cycle time, a theoretical cycle time, an actual cycle time, estimated actual cycle time, and/or one or more statistics such as a standard deviation, or variance for any of the cycle times mentioned. In embodiments, the at least one process information can include information, such as, an average or expected time required for the task, a percent Availability of the Equipment used to perform the task and, optionally, the user can provide information on a lot size and a Setup Time per lot, and a theoretical throughput (units per time) through that task.

In embodiments, each task of the at least one task can be evaluated to determine if it is a bottleneck of the at least one manufacturing process utilizing the one or more data items. In embodiments, the one or more data items, such as one or more of the at least one timing information, the at least one process information, are utilized for each task to determine a performance rate for each task of the at least one task, such as an effective throughput of each task of the at least one task. In embodiments, a task with the poorest performance rate, i.e. slowest effective throughput, can be identified as the bottleneck. Once a task is identified as the bottleneck, a cycle time for the bottleneck task is calculated using Kingman's Equation, Cycle Time=(Variability)*(Utilization)*(Process Time).

In embodiments, once a bottleneck task has been determined, and a cycle time calculated for the bottleneck task, each additional task (i.e. all non-bottleneck tasks) can have a cycle time calculated, estimated, and/or provided from the one or more data items. For example, the user can optionally enter a minimum or theoretical cycle time for each additional task and a standard deviation or variance of the actual cycle time; or enter an estimate of the actual cycle time and the theoretical cycle time and variance of the cycle time can be estimated based on defaults from previous analyses, (i.e. the theoretical cycle time is generally approximately one third of the actual cycle time and that the variance is generally a tenth of the square of the actual cycle time). In embodiments, a total non-bottleneck cycle time is calculated by summing the cycle time for each non-bottleneck task, and a total non-bottleneck variance is calculated by summing the cycle time variance for each non-bottleneck task. An initial estimate of total cycle time can be calculated by adding the total non-bottleneck cycle time and the cycle time for bottleneck task.

The theoretical estimate of total cycle time can be refined to a final total cycle time by utilizing Work In Process Inventory, provided by the user, and calculated through Little's Law. In embodiments, the higher cycle time of the theoretical estimate of total cycle time and the final total cycle time, is utilized as a Cycle Time Model.

In embodiments, Cycle Time Modeling Step 204 creates the theoretical minimum cycle time for the process consisting of the tasks, and predicts the average cycle time as a function of the percent utilization of equipment and resources through the bottleneck. Cycle Time Modeling Step 204 can process the information and provides at least one output 214 such as a graphical representation of the cycle time as a distribution, displayed as a histogram, and also as a function of work in process inventory and percent utilization of the bottleneck. Finally, one or more suggestions can be provided to the user as an output 214 on ways to improve the cycle time in terms of work in process inventory before each process task and the percent utilization of the bottleneck.

At a Throughput Modeling step 206, information provided by the user for Cycle Time Modeling to identify the most likely bottleneck and the throughput for the bottleneck can be reused for throughput modeling. Throughput Modeling step 206 can provide a rank ordering of potential bottlenecks and the potential factors that could cause the bottleneck to materialize. Throughput Modeling step 206 can provide suggestions as an output 214 to the user on ways to improve the throughput and associated costs and benefits of actions based on the suggestions.

At an On Time Delivery Modeling step 208, the user can provide at least one on-time delivery data item, such as a required quantity of product from manufacturing for delivery in a given timeframe and/or for a given order; a desired probability of On Time Delivery, or a default value can be provided, such as 95%; and/or one or more values for the cost of missed delivery and the unit cost of holding inventory. Additionally, On Time Delivery Modeling step 208 can reuse the information provided by the user for Yield Modeling step 202, such as the overall Beta distribution parameters developed in the Yield Modeling step 202 to provide a cumulative distribution of Yield. In embodiments, the overall Beta distribution parameters can be utilized to develop a Beta distribution for the probability of delivering the quantity required, and associated quantities of starting material(s) required given the yield distribution. For example, the cumulative distribution of Yield can be multiplied by the required quantity of product from manufacturing for delivery in a given timeframe to predict a probability of Ontime Delivery. Alternatively, the cumulative distribution of Yield can be utilized with the user provided desired probability of On Time Delivery to recommend an amount of material that should be started in the manufacturing process to achieve the user desired probability of On Time Delivery.

In embodiments, the On Time Delivery Modeling step 208 can reuse the information provided by the user for the Cycle Time modeling step 204 to develop a Gamma distribution for the probability of delivering the product within the given timeframe. In embodiments, the On Time Delivery Modeling step 208 can provide a graphic representation of the combination of inventory holding cost and missed delivery costs, and the combination, versus On Time Delivery probabilities. The On Time Delivery Modeling step 208 can provide suggestions to the user on ways to achieve the desired probability of On Time Delivery, and the associated tradeoffs including costs.

In embodiments, a probability that the product will be delivered on or before the promised date uses the Gamma distribution for the Cycle Time model, as discussed earlier, to provide a cumulative distribution of Cycle time. This cumulative distribution can directly provide a probability that material started on a certain date will be delivered on time allowing for cycle time variability, or alternatively can be used to recommend a date when the material should be started into the manufacturing line to achieve a selected probability of On Time Delivery. In embodiments, the On Time Delivery modeling step 208, can multiply the two probabilities determined, i.e. the probability that enough product will be manufactured and the probability that the product will be delivered one or before the promised date which can be provided as an output 214, and which can be utilized to provide one or more suggestions or recommendations to the user which can be provided as output 214.

At a Cost Modeling step 210, the user can provide information regarding the fixed costs for the manufacturing process, such as costs for the facilities and equipment. The user can provide information regarding the variable costs for the manufacturing process, such as material costs and unit costs associated with each task in the manufacturing process. In embodiments, Cost modeling step 210 can combine the cost information with yield information and throughput information to provide a probability distribution for the cost per unit. Cost Modeling step 210 can provide the sensitivity of the cost per unit to the throughput and the yield, and provides recommendations for cost optimization. For example, because the model is fully integrated, the user can compare different options, brainstorm different ideas, and see the impact on all manufacturing metrics—Yield, Cycle Time, On Time Delivery, Throughput and Cost, and predict the cost/benefit of each alternative. In embodiments, each alternative can be displayed, as an output 214, in terms of the Cost vs Benefit, and can be prioritized accordingly.

At Financial Results Modeling step 212, the user can provide information regarding the anticipated price per unit sold and the demand per unit of time. In embodiments, the user provide information, such as price, and/or demand, can be combined with information and/or outputs from one or more of Yield Modeling Step 202, Cycle Time Modeling Step 204, Throughput Modeling step 206, and Cost Modeling Step 210, to provide a probability distribution for financial results such as Gross Margin per unit of time. In embodiments, one or more simulations can provide the sensitivity of financial results to the yield, variable cost, fixed cost, price and throughput and provides recommendations for Gross Margin optimization. In embodiments, the one or more simulations can be a Monte Carlo Simulation wherein the values, such as values from the Yield Modeling Step 202 and Throughput Modeling Step 206 can be varied several times, to calculate various Gross Margins, Revenues, and/Costs can be calculated and summarized. Finally, a dashboard, or output 214, can be provided as a visual summary of the Manufacturing Metrics (Yield, Cycle Time, Throughput, On Time Delivery, Cost) and Financial Results.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/of” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

We claim:

1. A system for stochastic optimization of a process, comprising:
at least one processor, and at least one memory storing instructions that, when executed cause the at least one processor to perform a method, the method comprising:
receiving, at the at least one processor, a plurality of tasks associated with the process;
receiving, at the at least one processor, at least one data item associated with each task of the plurality of tasks;
providing, by the processor, the at least one data item to one or more modeling modules;
analyzing, using the one or more modelling modules, the at least one data item to determine at least one metric associated with the plurality of tasks;
outputting, via at least one user interface, the at least one metric, or at least one recommendation for improving the at least one metric.

2. The system of claim 1, wherein the one or more modelling modules are one of:
a yield modeling module configured to determine a yield model the process;
a cycle time modeling module configured to determine an overall cycle time model of the process;
a throughput modeling module configured to rank one or more throughputs;
an on-time delivery modeling module configured to determined one or more on-time delivery data items;
a cost modeling module configured to determine one or more costs of the process; or
a financial results modeling module configured to determine one or more financial results of the process.

3. The system of claim 2, wherein determining the yield model of the process comprises:
determining, using the at least one data item, at least one expected average yield, and at least one standard deviation of the at least one expected average yield for each task of the plurality of tasks;
determining, using the at least one expected average yield and the at least one standard deviation, at least one parameter for a statistical distribution, wherein the statistical distribution is a Beta distribution, and the at least one parameter is an alpha parameter and a beta parameter for the Beta distribution; and
outputting the Beta distribution as the yield model.

4. The system of claim 2, wherein determining the overall cycle time comprises:
determining, using the at least one data item, a performance rate for each task of the plurality of tasks;
determining, based on the performance rate, at least one bottleneck task and at least one non-bottleneck task;
calculating a cycle time for the at least one bottleneck task;
determining a cycle time and a cycle time variance for the at least one non-bottleneck task;
calculating, using the cycle time for the at least one bottleneck task and the cycle time for the at least one non-bottleneck task, an estimated of total cycle time;
refining the estimated total cycle time, using one or more additional data items, to provide a final total cycle time; and
outputting, as the overall cycle time, one of the estimated total cycle time or the final total cycle time.

5. The system of claim 2, wherein determining one or more on-time delivery data items, comprises:
receiving at least one additional delivery data item;
determining, using the at least one additional delivery data item, the yield model, or the overall cycle time model, the one or more on-time delivery data items;
outputting the one or more on-time delivery data items.

6. A computer implemented method for stochastic optimization of a process, comprising:
receiving, by a processor, a plurality of tasks associated with the process;
receiving, by the processor, at least one data item associated with each task of the plurality of tasks;
providing, by the processor, the at least one data item to one or more modeling modules;
analyzing, using the one or more modelling modules, the at least one data item to determine at least one metric associated with the plurality of tasks;
outputting, via at least one user interface, the at least one metric, or at least one recommendation for improving the at least one metric.

7. The system of claim 1, wherein the one or more modelling modules are one of:
a yield modeling module configured to determine a yield model the process;
a cycle time modeling module configured to determine an overall cycle time model of the process;
a throughput modeling module configured to rank one or more throughputs;
an on-time delivery modeling module configured to determined one or more on-time delivery data items;
a cost modeling module configured to determine one or more costs of the process; or
a financial results modeling module configured to determine one or more financial results of the process.

8. The system of claim 2, wherein determining the yield model of the process comprises:
determining, using the at least one data item, at least one expected average yield, and at least one standard deviation of the at least one expected average yield for each task of the plurality of tasks;
determining, using the at least one expected average yield and the at least one standard deviation, at least one parameter for a statistical distribution, wherein the statistical distribution is a Beta distribution, and the at least one parameter is an alpha parameter and a beta parameter for the Beta distribution; and
outputting the Beta distribution as the yield model.

9. The system of claim 2, wherein determining the overall cycle time comprises:
determining, using the at least one data item, a performance rate for each task of the plurality of tasks;
determining, based on the performance rate, at least one bottleneck task and at least one non-bottleneck task;
calculating a cycle time for the at least one bottleneck task;
determining a cycle time and a cycle time variance for the at least one non-bottleneck task;
calculating, using the cycle time for the at least one bottleneck task and the cycle time for the at least one non-bottleneck task, an estimated of total cycle time;
refining the estimated total cycle time, using one or more additional data items, to provide a final total cycle time; and
outputting, as the overall cycle time, one of the estimated total cycle time or the final total cycle time.

10. The system of claim 2, wherein determining one or more on-time delivery data items, comprises:
receiving at least one additional delivery data item;
determining, using the at least one additional delivery data item, the yield model, or the overall cycle time model, the one or more on-time delivery data items;
outputting the one or more on-time delivery data items.
